(19) United States
(12) Patent Application Publication
(10) Pub. No.: US 2008/0021145 A1
(43) Pub. Date: Jan. 24, 2008

(54) Thermoplastic elastomer composition and production method of the same

(75) Inventors: Kohichi Iketani, Ichihara-shi (JP); Hironobu Shigematsu, Kobe-shi (JP); Nobuhiro Natsuyama, Ichihara-shi (JP)

Correspondence Address: SUGHRUE MION, PLLC, 2100 PENNSYLVANIA AVENUE, N.W., SUITE 800, WASHINGTON, DC, 20037, US

(73) Assignee: SUMITOMO CHEMICAL COMPANY, LIMITED, Tokyo (JP)

(21) Appl. No.: 11/822,035

(22) Filed: Jul. 2, 2007

(30) Foreign Application Priority Data
Jul. 4, 2006 (JP) 2006-184248

(51) Int. Cl. C08K 3/22; C08K 3/26

(52) U.S. Cl. 524/430; 524/425

(57) ABSTRACT

It is an object of the present invention to provide an olefin thermoplastic elastomer composition which, through dynamic crosslinking of an olefin resin and an ethylene-α-olefin copolymer rubber as polymer components, has excellent appearance of the extrusion molding while also having excellent physical properties such as compression set and tensile strength. The present invention is directed to a method for producing a thermoplastic elastomer composition having the steps of: dynamically heat treating the following components (A) to (D); adding a component (E) to a resulting composition; and kneading the resulting mixture, and a thermoplastic elastomer composition obtained by the production method,
(A): 40 to 95 parts by weight of an ethylene-α-olefin-based copolymer rubber;
(B): 5 to 60 parts by weight of a polyolefin-based resin;
(C): 0.1 to 20 parts by weight of a halogenated alkylphenolic resin-based crosslinking agent;
(D): 0.001 to 0.7 part by weight of iron oxide; and
(E): 0.1 to 20 parts by weight of a halogen capturing agent.

### FIELD OF THE INVENTION

The present invention relates to an olefin-based thermoplastic elastomer composition and a production method thereof. More specifically, the present invention relates to an olefin-based thermoplastic elastomer composition, and a production method thereof, comprising an olefin-based resin and an ethylene-α-olefin-based copolymer rubber as polymer components, which has excellent appearance of the extrusion molding of a composition obtained by a dynamic heat treatment while also having excellent physical properties such as tensile strength and compression set.

### BACKGROUND OF THE INVENTION

When obtaining a thermoplastic elastomer by dynamically heat treating an olefin resin and a rubber, it is already known to employ an alkylphenolic resin as the crosslinking agent together with tin chloride as the activator. Such thermoplastic elastomers are attracting attention in view of their streamlined steps and recyclability, because they do not require a vulcanization step but have the same molding processability as a thermoplastic resin. Such thermoplastic elastomers are being used in a broad range of applications, for instance in automotive parts, household electric appliance parts, medical device parts, electric wires and the like.

However, while the thermoplastic elastomers obtained by conventional techniques have satisfactory physical properties such as tensile strength and compression set, they suffer from the drawback of having poor appearance of the extruded article (see JP-A-4-63851 and Japanese Patent No. 3303005). The reason for this drawback is that if the resin crosslinking agent and the activator are added together all at once and then dynamic crosslinking is carried out, the crosslinking reaction proceeds at a very fast rate, whereby the morphology of the olefin resin and the rubber becomes unsuitable.

### BRIEF SUMMARY OF THE INVENTION

It is an object of the present invention to provide a method for producing an olefin-based thermoplastic elastomer composition, comprising an olefin-based resin and an ethylene-α-olefin-based copolymer rubber as polymer components, which, through dynamic crosslinking, has excellent appearance of an extrusion molding while also having excellent physical properties such as compression set, oil resistance and tensile strength.

One aspect of the present invention is directed to a method for producing a thermoplastic elastomer composition comprising the steps of:

dynamically heat treating the following components (A) to (D);

adding a component (E) to a resulting composition; and

kneading a resulting mixture,

(A): 40 to 95 parts by weight of an ethylene-α-olefin-based copolymer rubber;

(B): 5 to 60 parts by weight of a polyolefin-based resin;

(C): 0.1 to 20 parts by weight of a halogenated alkylphenolic resin-based crosslinking agent;

(D): 0.001 to 0.7 part by weight of iron oxide; and

(E): 0.1 to 20 parts by weight of a halogen capturing agent.

A second aspect of the present invention is directed to a thermoplastic elastomer composition obtained by the above-described production method.

### BRIEF DESCRIPTION OF THE DRAWING

FIG. 1 is a diagram illustrating the cylinder positions of a twin-screw extruder.

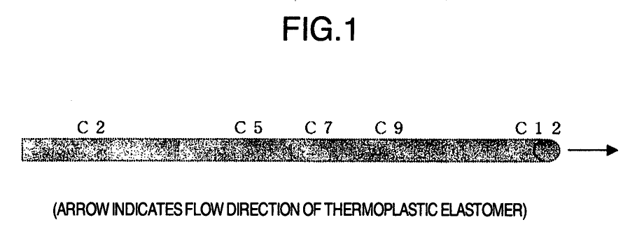

### DETAILED DESCRIPTION OF THE INVENTION

Component (A) of the present invention is an ethylene-α-olefin-based copolymer rubber. Specific examples include ethylene-α-olefin copolymer rubbers and ethylene-α-olefin-non-conjugated diene copolymer rubbers.

Examples of the α-olefin include propylene, 1-butene, 1-pentene, 1-hexene, 4-methyl-1-heptene, 1-octene, and 1-decene. Among these examples, propylene is preferred. Examples of the non-conjugated diene include 1,4-hexadiene, dicyclopentadiene, vinyl norbornene, and 5-ethylidene-2-norbornene.

The ratio (weight ratio) of ethylene/α-olefin in the component (A) is preferably 90/10 to 30/70. A mixture of the ethylene-α-olefin copolymer rubber and the ethylene-α-olefin-non-conjugated diene copolymer rubber may also be used. Further, an oil-extended rubber or a non-oil-extended rubber may be used. The content of the extender oil in the oil-extended rubber is preferably 20 to 200 parts by weight per 100 parts by weight of the copolymer rubber.

The extender oil provides effects such as lowering the hardness of the thermoplastic elastomer and improving oil resistance. If an oil-extended rubber is used, the weight of the extender oil is to be included in the weight of the copolymer rubber.

Preferable examples of the ethylene-α-olefin-based copolymer rubber include ethylene-propylene copolymer rubber having an ethylene/propylene weight ratio of 85/15 to 45/55.

The ethylene-α-olefin-based copolymer rubber preferably has a 100° C. Mooney viscosity (ML₁₊₄ 100° C.) of 10 to 350, and more preferably, 30 to 300. If the Mooney viscosity is too low, mechanical strength may be poor, while if the Mooney viscosity is too high, the molding appearance is harmed.

The content of the non-conjugated diene, when an ethylene-α-olefin-non-conjugated diene copolymer rubber is used, is preferably 1 to 30% by weight, and more preferably, 3 to 20% by weight. If the ethylene content exceeds 90% by weight, the obtained composition loses its flexibility, while if the ethylene content is less than 50% by weight, mechanical strength tends to decrease. Further, if the non-conjugated diene content is less than 1% by weight, mechanical strength tends to decrease as a result of the degree of crosslinking of the obtained composition failing to increase, while if the non-conjugated diene content exceeds 30% by weight, injection moldability and other such properties tend to deteriorate, which is disadvantageous from a cost viewpoint.

Component (B) of the present invention is a polyolefin-based resin. Examples of the polyolefin-based resin include a homopolymer or copolymers of ethylene, propylene, 1-butene, 1-pentene, 1-hexene, 4-methyl-1-pentene, 1-octene, and 1-decene. Among these examples, polypropylene is preferred.

Polypropylene is a publicly-known polymer, and may be polymerized by a publicly-known polymerization process. When polymerizing propylene, the propylene may be co-polymerized with an α-olefin such as ethylene, butene-1, pentene-1, and 4-methylpentene-1. While an isotactic structure is preferred as a stereostructure, other structures which can be used include a syndiotactic structure, a mixed isotactic and syndiotactic structure and a partially atactic structure. Polypropylene is a polymer having propylene as a main constituent, and examples thereof include propylene homopolymer and random copolymers or block copolymers of propylene-α-olefins. The melt flow rate of the polypropylene (measured in accordance with JIS K6758 at a temperature of 230° C. with a load of 21.18 N) is preferably 0.05 to 100 g/10 min, and more preferably, 0.1 to 50 g/10 min.

Component (C) of the present invention is a halogenated alkylphenolic resin-based crosslinking agent.

While a heat crosslinkable phenolic resin can be produced by a publicly-known reaction method, in the present invention an alkylphenolic resin comprising a methylol group and a brominated alkylphenolic resin in which a terminal hydroxyl group is brominated are provided as the component (C) crosslinking agent. Of these examples, a brominated alkylphenolic resin is preferred, because alkylphenolic resins comprising a methylol group may have considerable corrosion properties of the production equipment since a chlorine activator is necessary. The brominated alkylphenolic resin crosslinking agent can include compounds represented by the following formula.

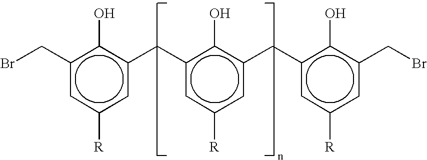

(In the above formula, n represents an integer of from 0 to 10, R represents a saturated hydrocarbon group having carbon atom of from 1 to 15.)

Component (D) of the present invention is iron oxide.

Component (E) of the present invention acts as a halogen capturing agent, and is preferably a substance which has a bromine capturing action. More preferably, component (E) is at least one selected from among zinc oxide, magnesium oxide, hydrotalcite, calcium oxide, and calcium carbonate. Among these, zinc oxide and magnesium oxide are especially preferable. Examples of compounds which can be used as the zinc oxide include a broad range of a compounds, such as those for rubber, for coatings and for printing. Such compounds can be one kind, two kinds, activated zinc or the like, and are not limited in their particle size.

Further, examples of compounds which can be used as the magnesium oxide include those for rubber, for resins, for food additives and the like regardless of particle size.

The content of each of the components used in the production method according to the present invention is as follows. The content of component (A) is 40 to 95 parts by weight and the content of component (B) is 5 to 60 parts by weight (however, the total of components (A) and (B) is 100 parts by weight). Based on a component (A) and component (B) total of 100 parts by weight, the content of component (C) is 0.1 to 20 parts by weight, the content of component (D) is 0.001 to 0.7 parts by weight and the content of component (E) is 0.1 to 20 parts by weight. When an oil-extended rubber is used, the component (A) content includes the extender oil. Further, when two or more types of a component are used together, the content of the respective components refer to the total content.

One of the largest characteristics of the present invention is that the added amount of the component (D) iron oxide (crosslinking activator) is preferably a minute amount. When the amount of component (D) is minute, the crosslinking rate is slowed and dynamic crosslinking proceeds well, so that the morphology of the olefin resin and the rubber is desirable, and the appearance of the extrusion molding tend to be improved. Since the added amount of component (D) is minute, if the component (E) halogen capturing agent and the component (D) are added simultaneously and subjected to a dynamic heat treatment, the effects of component (D) as an activator are lost. This causes the degree of crosslinking to decrease, whereby physical properties such as compression set and tensile strength deteriorate. As a strategy to resolve this kind of problem, the present inventors discovered the concept of adding the components (A) to (D), subjecting the mixture to a dynamic heat treatment, and then adding component (E) to the obtained composition and kneading the resultant mixture, thereby arriving at the present invention.

In the present invention, to the extent that the advantageous effects are not harmed, other components may be employed according to the various objectives. Examples of such components include fillers, antioxidants, heat stabilizers, photostabilizers, UV absorbing agents, release agents, tackifiers, colorants, neutralizers, lubricants, dispersants, flame retardants, antistatic agents, conduction aids, antibacterial agents, disinfectants, carbon black, inorganic fillers such as talc, clay and silica, glass fiber, carbon fiber, process oil, and softeners.

The production method according to the present invention will now be described. In the production method according to the present invention, the components (A) to (D) are dynamically heat treated, and then component (E) is added to the resultant composition and the mixture is kneaded. According to the present invention, a thermoplastic elastomer having excellent extrusion processability can be obtained.

The weight ratio ((A)/(B)) of component (A) to component (B) is 40/60 to 95/5. If the amount of component (A) is too small, the obtained composition tends not to exhibit elasticity, while if the amount of component (A) is too large, flowability decreases and the appearance of the extruded article, injection-molded article or the like tends to be unacceptable. If the amount of component (B) is too small, flowability decreases and the appearance of the extruded article tends to be unacceptable, while if the amount of component (B) is too large, the hardness of the obtained composition increases, whereby flexibility tends to be lost.

Component (C) is a halogenated alkylphenolic resin-based crosslinking agent. Based on a component (A) and component (B) total of 100 parts by weight, the added amount of component (C) is 0.1 to 20 parts by weight. If the amount of component (C) is too small, the physical properties, such as tensile strength and compression set, of the obtained composition tend to deteriorate because a sufficient degree of crosslinking of the olefin copolymer rubber cannot be attained. On the other hand, if the amount of component (C) is too large, there tends to be the problems that the flowability of the obtained composition decreases, odor becomes stronger and costs become disadvantageous.

Component (D) acts as a crosslinking activator. Based on a component (A) and component (B) total of 100 parts by weight, the added amount of component (D) is 0.001 to 0.7 part by weight, preferably 0.001 to 0.5 part by weight, more preferably 0.001 to 0.3 part by weight, still more preferably 0.001 to 0.1 part by weight. If the amount of component (D) is too small, the degree of crosslinking of the olefin copolymer rubber tends to decrease, whereby the physical properties, such as heat resistance, tensile strength and compression set of the obtained composition tend to deteriorate. On the other hand, if the amount of component (D) is too large, the extrusion texture of obtained composition tends to deteriorate, because the crosslinking rate of the olefin copolymer rubber is increased.

Component (E) is a halogen capturing agent. Based on a component (A) and component (B) total of 100 parts by weight, the added amount of component (E) is 0.1 to 20 parts by weight. If the amount of component (E) is too small, the capturing of halogen gas produced in the crosslinking reaction by the dynamic heat treatment is insufficient, which tends to give rise to problems such as corrosion of the production apparatus and environmental pollution. On the other hand, if the amount of component (E) is too large, while such problems are overcome, the physical properties, such as tensile strength and compression set, of the obtained composition tend to deteriorate.

Component (E) is added after components (A) to (D) have been added and subjected to a dynamic heat treatment. If components (A) to (E) are added simultaneously and the dynamic heat treatment is carried out, the degree of crosslinking decreases, whereby the physical properties, such as tensile strength and compression set, of the obtained composition deteriorate. Further, if zinc oxide is used as component (E), and components (A) to (E) are added simultaneously, the crosslinking rate increases, so that although the physical properties, such as tensile strength and compression set, of the obtained composition are good, the appearance of the extruded article deteriorate.

The present invention is a method for producing a thermoplastic elastomer composition comprising the steps of adding components (A) to (D) together, subjecting the resultant mixture to a dynamic heat treatment, adding component (E) to the obtained composition, and kneading the resultant mixture. Examples of apparatuses which may be employed for the dynamic heat treatment include publicly-known apparatuses, such as an open-type mixing roll, a closed-type Banbury mixer, a kneader, an extruder, and a twin-screw extruder. Further, two or more of these apparatuses may be employed together. However, in terms of productivity, it is preferable to use a twin-screw extruder. The conditions (temperature and time) for the dynamic heat treatment are preferably 150 to 300° C., and more preferably, 170 to 280° C., for a duration of 0.5 to 30 minutes, and preferably, 1 to 20 minutes. The kneading conducted, after the addition of component (E), can be carried out using the same apparatus and method as for the dynamic heat treatment.

The thermoplastic elastomer composition obtained by the present invention may be formed using commonly employed molding methods, such as injection molding, extrusion molding, hollow molding, and compression molding. The thermoplastic elastomer composition is used as a material in a broad range of fields, for applications such as automotive parts (e.g., weather strips, ceiling materials, interior seats, bumper moldings, side moldings, air spoilers, air duct hoses, cup holders, side brake grips, shift knobs covers, seat adjustment latches, flapper door seals, wire harness grommets, rack and pinion boots, suspension cover boots, glass guides, inner beltline seals, roof guides, trunk lid seals, molded quarter window gaskets, corner moldings, glass encapsulation, hood seals, glass run channels, secondary seals, various packings), building parts (e.g., water stops, joint sealers, building window frames), sports equipment (e.g., golf clubs, tennis racquet grips), industrial parts (e.g., hose tubes, gaskets), household electric appliance parts (e.g., hoses, packing), medical device parts, electric wires, and miscellaneous goods.

### EXAMPLES

The present invention will now be described in more detail with reference to the following examples. However, the present invention is not limited to the following examples, as long as one does not deviate from the gist of the present invention.

The raw materials and evaluation methods used in the following examples were as follows.

### [Raw Materials]

EPDM (component (A)): Ethylene-propylene-5-ethylidene-2-norbornene copolymer rubber (“Esprene 670F”, manufactured by Sumitomo Chemical Co., Ltd.) 100 parts of a paraffinic oil extender

PP-1 (component (B)): Polypropylene (“Nobrene HR100”, manufactured by Sumitomo Chemical Co., Ltd.)

Antioxidant: Irganox 1010 (manufactured by Ciba Specialty Chemicals)

Phenolic resin (component (C)): Brominated alkylphenolic resin (manufactured by Taoka Chemicals Co., Ltd.; Tackrol 250-I)

Iron oxide (component (D)): Iron(III) oxide and iron(IV) oxide (both manufactured by Kanto Chemical Co., Inc.; extra-pure reagent)

Zinc oxide (component (E)): Two kinds of zinc oxide (manufactured by Seido Chemical Industry Co., Ltd.)

Magnesium oxide (component (E)): Kyowa Mag 150 (manufactured by Kyowa Chemical Industry Co., Ltd.)

### [Evaluation Method]

A thermoplastic elastomer composition obtained by the present invention was compression-molded at 200° C. to produce a test specimen of 2 mm thick. The physical properties of this specimen were then evaluated according to the following method.

Hardness: In compliance with JIS K6253 (Shore-A momentary value)

Tensile strength at break: In compliance with JIS K6251 (JIS No. 3 dumbbell, stretching rate 200 mm/min)

Elongation: Same as above

Compression set: In compliance with JIS K6262 (70° C., 22 hours, 25% compression)

Extrusion texture surface roughness (Rz) and extrusion texture practical usability evaluation: Using a 25 mmφ single screw extruder (manufactured by Union Plastics Co., Ltd., L/D of 20, full flight screw, and a flat die having a width of 100 mm and a thickness of 1 mm), molding was carried out under conditions of a molding temperature of 150° C. at the hopper section, 220° C. at the cylinder and 220° C. at the die, at a screw rotation speed of 40 rpm. The surface of the obtained extrusion molding was measured for its average roughness Rz over 10 points by a surface roughness measuring instrument SURFCOM manufactured by Tokyo Seimitsu Co., Ltd. (in compliance with JIS B0601). In addition, the merits of practical use were visually evaluated by indicating with ◯ or X (◯ if practical use possible, and X if practical use not possible).

Determination of extruder corrosion properties: A dynamic heat treatment was carried out using a twin-screw extruder under the following conditions, and then a screw removed from the extruder was heat treated for 1 hour at 450° C. in a cleaning furnace (“Full Clean IFB” model, manufactured by Toray Engineering Co., Ltd.). The screw corrosion state was then determined (◯ if no corrosion, and X if even a small amount of corrosion was deemed to exist).

### Examples 1 to 5 and Comparative Examples 1 to 5

The examples will now be described in more detail. The added amount of the materials are listed in terms of the total weight of component (A) and component (B) being set at 100 parts by weight (see Table 1).

Using the twin-screw extruder TEX44HCT (manufactured by The Japan Steel Works Ltd., L/D=42), components (A) to (D) were added from cylinder 2 position and component (E) was added from cylinder 9 position under the basic conditions of a rotation speed of 280 rpm, a cylinder temperature of C1 to C2: 30° C., C3 to C4: 150° C., C5 to C11: 185° C., C12: 200° C., a head temperature of 200° C. and an extrusion rate of 50 kg/hr.

In Example 1, 0.01 parts by weight of iron(III) oxide (component (D)) were added from the cylinder 2 position, and 0.3 parts by weight of zinc oxide (component (E)) were added from the cylinder 9 position. Example 2 was carried out in the same manner as Example 1, except that 0.03 parts by weight of iron(III) oxide (component (D)) were added from the cylinder 2 position. Example 3 was carried out in the same manner as Example 2, except that 0.3 parts by weight of magnesium oxide (component (E)) were added from the cylinder 9 position. Example 4 was carried out in the same manner as Example 1, except that the added amount of phenolic resin (component (C)) was 3.6 parts by weight. Example 5, iron(IV) oxide (component (D)) was added from the cylinder 2 position, and 0.8 parts by weight of zinc oxide (component (E)) were added from the cylinder 9 position. All of the obtained products had excellent extrusion texture and compression set, yet there was no corrosion of the extruder screws.

In Comparative Example 1, there was corrosion of the extruder screws because component (E) was not added. In Comparative Example 2, although 1 part by weight of zinc oxide was added from the cylinder 9 position as component (E), no iron oxide (component (D)) was added from the cylinder 2 position, which made the extrusion texture deteriorate. In Comparative Example 3, a large amount (0.8 parts by weight) of iron(III) oxide (component (D)) was added from the cylinder 2 position, which made the extrusion texture deteriorate. In Comparative Example 4, a large amount (1.5 parts by weight) of iron(IV) oxide (component (D)) was added, which made the extrusion texture deteriorate. In Comparative Example 5, the composition was not able to be extruded and there was corrosion of the extruder screws because component (D) was not added from the cylinder 2 position and component (E) was not added from the cylinder 9 position.

TABLE 1

| | Example | | | | | Comparative Example | | | | |
|---|---|---|---|---|---|---|---|---|---|---|
| | 1 | 2 | 3 | 4 | 5 | 1 | 2 | 3 | 4 | 5 |
| EPDM | 77 | 77 | 77 | 77 | 77 | 77 | 77 | 77 | 77 | 77 |
| PP 1 | 23 | 23 | 23 | 23 | 23 | 23 | 23 | 23 | 23 | 23 |
| Antioxidant | 0.1 | 0.1 | 0.1 | 0.1 | 0.1 | 0.1 | 0.1 | 0.1 | 0.1 | 0.1 |
| Phenolic resin | 2.4 | 2.4 | 2.4 | 3.6 | 2.4 | 2.4 | 2.4 | 2.4 | 2.4 | 2.4 |
| Iron (III) oxide | 0.01 | 0.03 | 0.03 | 0.01 | — | 0.01 | — | 0.8 | — | — |
| Iron (IV) oxide | — | — | — | — | 0.01 | — | — | — | 1.5 | — |
| Post-addition | | | | | | | | | | |
| Zince oxide | 0.3 | 0.3 | — | 0.3 | 0.8 | — | 1.0 | — | 3.0 | — |
| Magnesium oxide | | | 0.3 | | | | | 1 | — | — |
| Physical properties | | | | | | | | | | |
| Hardness | 83 | 84 | 84 | 84 | 84 | 83 | 83 | 84 | 84 | not |
| Tensile strength at break | 13.3 | 14.4 | 13.9 | 14.2 | 14.9 | 13.0 | 14.8 | 12.8 | 11.4 | sheet |
| (MPa) | | | | | | | | | | extruded |
| Elongation (%) | 680 | 660 | 650 | 600 | 580 | 630 | 670 | 650 | 690 | |
| CS (%) 70° C. × 22 hrs | 33.4 | 32.6 | 34.2 | 31.0 | 31.5 | 36.1 | 32.7 | 34.8 | 36.1 | |
| Extrusion surface | 12.1 | 13.4 | 12.5 | 13.3 | 13.6 | 12.7 | 28.5 | 30.2 | 35.2 | |
| roughness (μm) | | | | | | | | | | |
| Determination of the | ◯ | ◯ | ◯ | ◯ | ◯ | ◯ | X | X | X | X |
| practical usability of | | | | | | | | | | |
| the extrusion texture | | | | | | | | | | |
| Extruder corrosion | ◯ | ◯ | ◯ | ◯ | ◯ | X | ◯ | ◯ | ◯ | X |
| properties | | | | | | | | | | |

### ADVANTAGES OF THE INVENTION

According to the present invention, an olefin thermoplastic elastomer composition can be provided which, through dynamic crosslinking of an olefin resin and an ethylene-α-olefin copolymer rubber as polymer components, has excellent appearance of the extrusion molding while also having excellent physical properties such as compression set and tensile strength.

1. A method for producing a thermoplastic elastomer composition comprising the steps of:
dynamically heat treating the following components (A) to (D);
adding a component (E) to a resulting composition; and
kneading a resulting mixture,
(A): 40 to 95 parts by weight of an ethylene-α-olefin-based copolymer rubber;
(B): 5 to 60 parts by weight of a polyolefin-based resin;
(C): 0.1 to 20 parts by weight of a halogenated alkylphenolic resin-based crosslinking agent;
(D): 0.001 to 0.7 part by weight of iron oxide; and
(E): 0.1 to 20 parts by weight of a halogen capturing agent.

2. The method for producing a thermoplastic elastomer composition according to claim 1, wherein the component (C) is a brominated alkylphenolic resin-based crosslinking agent.

3. The method for producing a thermoplastic elastomer composition according to claim 1, wherein component (E) is at least one component selected from the group consisting of zinc oxide, magnesium oxide, hydrotalcite, calcium oxide, and calcium carbonate.

4. A thermoplastic elastomer composition obtained by a method for producing a thermoplastic elastomer composition comprising the steps of:
dynamically heat treating the following components (A) to (D);
adding a component (E) to a resulting composition; and
kneading a resulting mixture,
(A): 40 to 95 parts by weight of an ethylene-α-olefin-based copolymer rubber;
(B): 5 to 60 parts by weight of a polyolefin-based resin;
(C): 0.1 to 20 parts by weight of a halogenated alkylphenolic resin-based crosslinking agent;
(D): 0.001 to 0.7 part by weight of iron oxide; and
(E): 0.1 to 20 parts by weight of a halogen capturing agent.

5. The thermoplastic elastomer composition according to claim 4, wherein the component (C) is a brominated alkylphenolic resin-based crosslinking agent.

6. The thermoplastic elastomer composition according to claim 4, wherein the component (E) is at least one component selected from the group consisting of zinc oxide, magnesium oxide, hydrotalcite, calcium oxide, and calcium carbonate.
